(19) United States
(12) Patent Application Publication
(10) Pub. No.: US 2009/0213279 A1
(43) Pub. Date: Aug. 27, 2009

(54) PROJECTOR SYSTEM, PROJECTOR, AND REMOTE CONTROLLER

(75) Inventor: Hiroyuki ICHIEDA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/389,850

(22) Filed: Feb. 20, 2009

(30) Foreign Application Priority Data
Feb. 25, 2008 (JP) 2008-042784

(51) Int. Cl. H04N 5/44; H04N 9/31

(52) U.S. Cl. 348/734; 348/744; 348/E05.096; 348/E09.025

(57) ABSTRACT

A projector system includes a projector which has a plurality of image input sections receiving image input signals, and a remote controller which remotely operates the projector, the remote controller including an operation unit which has a plurality of selection operation sections correlated to the plurality of image input sections, and a signal generation and transmission unit which generates an operation signal corresponding to an operation of each of the selection operation sections, and transmits it to the projector, and the projector including a receiving unit which receives the operation signal transmitted by the signal generation and transmission unit, a picture processing unit which generates a display picture signal from the image input signals, based on the operation signal received by the receiving unit, and a projection section which projects a picture based on the display picture signal, wherein, in the event that the receiving unit receives at least two of the operation signals within a predetermined time, the picture processing unit generates a display picture signal which represents a combined picture based on the image input signals corresponding to the operation signals received within the predetermined time.

### BACKGROUND

1. Technical Field

The present invention relates to a projector system, a projector, and a remote controller.

2. Related Art

Among picture display apparatus (for example, a television or a projector) which have a plurality of input sources, there are picture display apparatus which can switch between using a single picture display, which displays a picture corresponding to one input source on one screen, and a combined picture display, which simultaneously displays pictures corresponding to two input sources combined on one screen. Among these kinds of picture display apparatus, one is known which is configured in such a way that, by providing, for example, a dedicated switching button in an operation section, a user can switch at will between the single picture display and the combined picture display (refer to JP-A-6-38130).

In the case of, for example, adopting a configuration in which a dedicated switching button is provided in the operation section, as it is not an operation which can necessarily be understood intuitively, the burden of learning a new operation is considerable for a user who is not used to the operation. Also, there is a problem in that more parts are needed than in a picture display apparatus which does not switch between a single picture display and a combined picture display.

### SUMMARY

An advantage of some aspects of the invention is to provide a projector system, a projector, and a remote controller, which can be operated intuitively, and in which the number of parts is reduced.

(1) A projector system according to one aspect of the invention includes a projector which has a plurality of image input sections receiving image input signals, and a remote controller which remotely operates the projector. The remote controller includes an operation unit which has a plurality of selection operation sections correlated to the plurality of image input sections, and a signal generation and transmission unit which generates an operation signal corresponding to an operation of each of the selection operation sections, and transmits it to the projector. The projector includes a receiving unit which receives the operation signal transmitted by the signal generation and transmission unit, a picture processing unit which generates a display picture signal from the image input signals, based on the operation signal received by the receiving unit, and a projection section which projects a picture based on the display picture signal. In the event that the receiving unit receives at least two of the operation signals within a predetermined time, the picture processing unit generates a display picture signal which represents a combined picture based on the image input signals corresponding to the operation signals received within the predetermined time.

According to this aspect of the invention, it is possible to provide a projector wherein, without increasing the number of parts in an operation portion, it is possible to intuitively select a combination of images from a plurality of image input sections.

(2) The projector system of the aspect of the invention may be configured such that, in the event that the receiving unit receives at least two of the operation signals in operational order within the predetermined time, the picture processing unit generates a display picture signal which represents a combined picture, with a disposition correlated in advance to the operational order, based on the image input signals corresponding to the operation signals received within the predetermined time.

(3) The projector system of the aspect of the invention may be configured such that, in the event that the receiving unit receives any one of the operation signals corresponding to the combined picture being projected, the picture processing unit generates a display picture signal which represents a single picture based on the image input signal corresponding to the operation signal received.

(4) The projector system of the aspect of the invention may be configured such that the operation unit includes a thumbnail operation section, the signal generation and transmission unit generates a thumbnail operation signal corresponding to an operation of the thumbnail operation section, and transmits it to the projector and, in the event that the receiving unit receives the thumbnail operation signal, the picture processing unit generates a display picture signal which represents a combined picture based on all the image input signals input into the plurality of image input sections.

(5) A projector according to another aspect of the invention has a plurality of image input sections receiving image input signals. The projector includes an operation unit which has a plurality of selection operation sections correlated to the plurality of image input sections, a signal generation unit which generates an operation signal correlated to an operation of each of the selection operation sections, a picture processing unit which generates a display picture signal from the image input signals, based on the operation signal, and a projection section which projects a picture based on the display picture signal. In the event that the picture processing unit accepts at least two of the operation signals within a predetermined time, the picture processing unit generates a display picture signal which represents a combined picture based on the image input signals corresponding to the operation signals accepted within the predetermined time.

(6) The projector of the aspect of the invention may be configured such that, in the event that the picture processing unit accepts at least two of the operation signals in operational order within the predetermined time, the picture processing unit generates a display picture signal which represents a combined picture, with a disposition correlated in advance to the operational order, based on the image input signals corresponding to the operation signals accepted within the predetermined time.

(7) The projector of the aspect of the invention may be configured such that, in the event that the picture processing unit accepts any one of the operation signals corresponding to the combined picture being projected, the picture processing unit generates a display picture signal which represents a single picture based on the image input signal corresponding to the operation signal accepted.

(8) The projector of the aspect of the invention may be configured such that the projector comprises a thumbnail operation section for sending a thumbnail operation signal, in the event that the picture processing unit accepts the thumbnail operation signal corresponding to an operation of the thumbnail operation section, the picture processing unit generates a display picture signal which displays a combined picture based on all the image input signals input into the plurality of image input sections.

(9) A remote controller according to another aspect of the invention remotely operates a projector which has a plurality of image input sections receiving image input signals. The remote controller includes an operation unit which has a plurality of selection operation sections correlated to the plurality of image input sections, and a signal generation and transmission unit which generates an operation signal corresponding to an operation of each of the selection operation sections, and transmits it to the projector. The operation unit includes a thumbnail operation section, and the signal generation and transmission unit generates a thumbnail operation signal, corresponding to an operation of the thumbnail operation section, instructing a display of a combined picture based on all the image input signals input into the plurality of image input sections, and transmits it to the projector.

The projector remotely operated by the remote controller of the aspect of the invention may include, for example, an operation unit which has a plurality of selection operation sections corresponding to the plurality of image input sections, a signal generation unit which generates an operation signal correlated to an operation of each of the selection operation sections, a picture processing unit which generates a display picture signal from the image input signals, based on the operation signal, and a projection section which projects a picture based on the display picture signal, and, in the event that the picture processing unit accepts at least two of the operation signals within a predetermined time, the picture processing unit generates a display picture signal which represents a combined picture based on the image input signals corresponding to the operation signals accepted within the predetermined time.

Furthermore, the projector may be configured such that the projector further comprises a thumbnail operation section for sending a thumbnail operation signal, in the event that the picture processing unit accepts the thumbnail operation signal corresponding to the operation of a thumbnail operation section, the picture processing unit generates a display picture signal which represents a combined picture based on all the image input signals input into the plurality of image input sections.

The invention can be realized not only in an embodiment as a projector system, but also in an embodiment as a picture display system including a picture display apparatus other than a projector, and a remote controller.

### BRIEF DESCRIPTION OF THE DRAWINGS

The invention will be described with reference to the accompanying drawings, wherein like numbers reference like elements.

FIG. 1 is a functional block diagram of a projector system, a projector, and a remote controller in an embodiment.

FIG. 2 is a flowchart of the projector in the embodiment.

FIGS. 3A and 3B are diagrams for illustrating projection pictures of the projector in the embodiment.

FIGS. 4A and 4B are diagrams for illustrating projection pictures of the projector in the embodiment.

FIG. 5 is a diagram for illustrating a configuration of the remote controller in the embodiment.

FIGS. 6A to 6D are diagrams for illustrating a shift of a projection picture of the projector in the embodiment.

FIG. 7 is a diagram for illustrating a configuration of the projector in the embodiment.

FIG. 8 is a flowchart of a remote controller in a modification example.

### DESCRIPTION OF EXEMPLARY EMBODIMENTS

Hereafter, a detailed description will be given, using the drawings, of a preferred embodiment of the invention. The embodiment to be described hereafter does not unduly limit the details of the invention described in the claims. Also, it does not necessarily follow that all configurations to be described hereafter are essential configuration requirements of the invention.

A projector system 1 of the embodiment is configured of a projector 10, and a remote controller 20. Although it is possible to carry out basic operations of the projector system 1 by operating various kinds of operation section provided in the projector 10, in the embodiment, it is configured in such a way that it is possible to remotely operate the projector 10 using the projector remote controller 20.

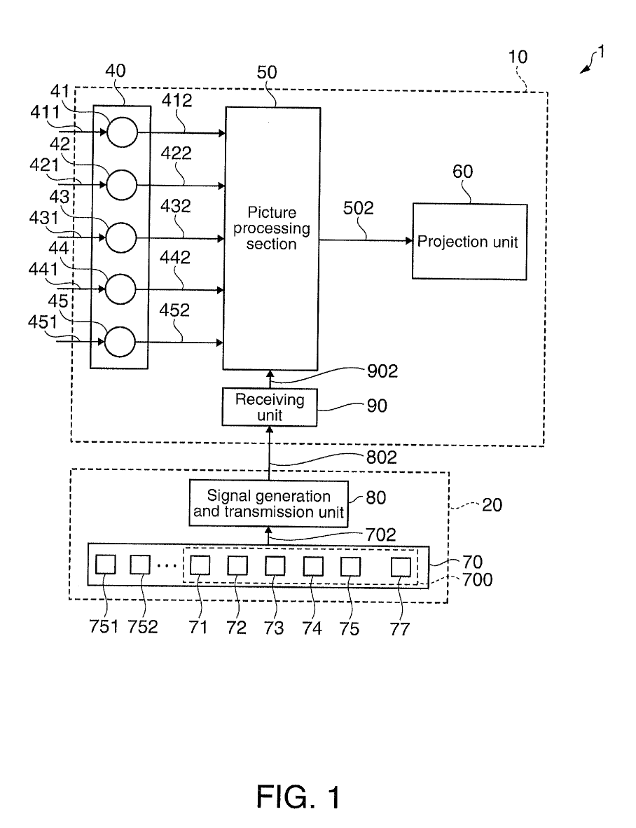

FIG. 1 is a functional block diagram of the projector system 1. Although, in the embodiment, functions belonging to the projector 10 and functions belonging to the remote controller 20 are separated, it is also acceptable to configure all of the functions in a projector main body as a unit, without having a remote controller.

The projector 10 in the embodiment includes an image input unit 40. The image input unit 40 has a plurality of image input sections. The image input unit 40 receives an image input signal from the exterior of the projector 10, and transmits it to a picture processing unit 50, to be described hereafter. In the embodiment, the image input unit 40 is configured of the plurality of image input sections 41 to 45. A variety of configurations are possible for the image input sections.

For example, as well as a wired input such as one from an RS-232C terminal, a BNC terminal, a component video terminal, a composite video terminal, an S video terminal, a DVI terminal, an HDMI terminal, a USB terminal, an IEEE1394 terminal, or an IEEE802.3 (a so-called Ethernet (registered trademark)) terminal, a configuration which can accept a wireless input, such as one from an IEEE802.11a/b/g/n (a so-called wireless LAN), or an IEEE802.15.1 (a so-called Bluetooth (registered trademark)), and a directly insertable storage medium, such as an SD memory card, are also included.

As image input signals 411, 421, 431, 441, and 451, it is acceptable that, for example, image input signals from a computer or an image reproduction apparatus are input, or that data stored on a storage medium are directly input.

In the embodiment, as one example, a description will be given of the projector allotting an RS-232C terminal (hereafter referred to as the “PC1”) as the image input section 41, a DVI terminal (hereafter referred to as the “PC2”) as the image input section 42, an S video terminal (hereafter referred to as the “S video”) as the image input section 43, a component video terminal (hereafter referred to as the “video”) as the image input section 44, and a USB terminal (hereafter referred to as the “USB”) as the image input section 45.

The projector 10 in the embodiment includes the picture processing unit 50. The picture processing unit 50 generates a predetermined display picture signal 502 from output signals 412, 422, 432, 442, and 452 of the image input unit 40, and transmits it to a projection section 60, to be described hereafter. It is acceptable that the picture processing unit 50 is configured using, for example, a CPU or a memory.

The picture processing unit 50 has a combined picture display processing function which, based on an operation signal 802, generates the display picture signal 502 displaying a combined picture based on image input signals from the plurality of image input sections 41 to 45. Also, it is also acceptable that the picture processing unit 50 has a single picture display processing function which, based on the operation signal 802, generates the display picture signal 502 displaying a single picture based on an image input signal from a single specified image input section. Furthermore, it is also acceptable that the picture processing unit 50 has a thumbnail picture display processing function which, based on the operation signal 802, generates the display picture signal 502 displaying a combined picture based on all the image input signals input into the plurality of image input sections 41 to 45.

It is also acceptable that the projector 10 in the embodiment includes the projection section 60. The projection section 60, based on the signal 502 output from the picture processing unit 50, projects an image onto a screen, or the like. It is acceptable that the projection section 60 is configured including, for example, a lamp and a lens.

The remote controller 20 in the embodiment includes an operation unit 70. The operation unit 70, based on a user's operation, transmits an output signal 702 to a signal generation and transmission unit 80, to be described hereafter. The operation unit 70 has a plurality of selection operation sections 71 to 75 corresponding to the plurality of image input sections 41 to 45. In the embodiment, the selection operation section 71 corresponds to the image input section 41, the selection operation section 72 to the image input section 42, the selection operation section 73 to the image input section 43, the selection operation section 74 to the image input section 44, and the selection operation section 75 to the image input section 45. The selection operation sections 71 to 75 are used for selecting an input source (for example, a computer or an image reproduction apparatus) of an image the user wishes to project. It is acceptable that the selection operation sections 71 to 75 are configured as, for example, buttons or touch panels.

It is also acceptable that the operation unit 70 includes a thumbnail operation section 77. The thumbnail operation section 77 is used when wishing to project a combined picture of all the images input into the image input sections 41 to 45. It is acceptable that the thumbnail operation section 77 is configured as, for example, a button or a touch panel.

In FIG. 1, the selection operation sections 71 to 75, and the thumbnail operation section 77, are taken as an operation section group 700. Also, there is no objection to the operation unit 70 including, as well as the operation section group 700, other operation sections. In FIG. 1, operation sections 751 and 752 are shown as other operation sections.

The remote controller 20 in the embodiment includes the signal generation and transmission unit 80. The signal generation and transmission unit 80, based on the output signal 702 of the operation unit 70, transmits the operation signal 802, corresponding to an operation of each of the selection operation sections 71 to 75 and thumbnail operation section 77, as well as the operation sections 751 and 752, to a receiving unit 90, to be described hereafter. It is acceptable that the signal generation and transmission unit 80 is configured using, for example, a semiconductor integrated circuit. It is acceptable that the operation signal 802 is transmitted by, for example, infrared communication. Also, it is acceptable that the operation signal 802 is a selection operation section operation signal corresponding to an operation of any of the selection operation sections 71 to 75, a thumbnail operation section operation signal corresponding to an operation of the thumbnail operation section 77, or an other operation section operation signal corresponding to an operation of either of the other operation sections 751 and 752.

The projector 10 in the embodiment includes the receiving unit 90. The receiving unit 90 receives the operation signal 802 from the signal generation and transmission unit 80, and transmits an output signal 902 to the picture processing unit 50. It is acceptable that the receiving unit 90 receives the operation signal 802 by, for example, infrared communication.

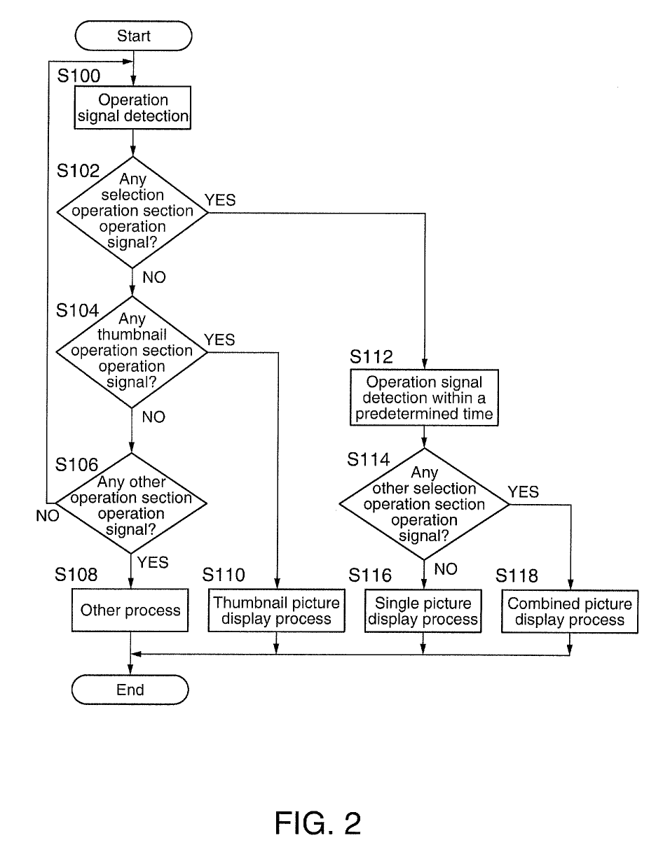

Next, a description will be given of an operation of the projector system 1 in the embodiment. FIG. 2 is a flowchart showing one example of an operation of the projector 10 in the embodiment. It will be taken that the remote controller 20 in the embodiment, based on the user's operation, transmits the operation signal 802 corresponding to each of the selection operation sections 71 to 75, the thumbnail operation section 77, and the operation sections 751 and 752, to the projector 10. Also, an operation signal corresponding to an operation of any of the selection operation sections 71 to 75 will be taken to be a selection operation section operation signal, an operation signal corresponding to an operation of the thumbnail operation section 77 to be a thumbnail operation section operation signal, and an operation signal corresponding to an operation of either of the other operation sections 751 and 752 to be an other operation section operation signal.

Firstly, the projector 10 detects whether or not the receiving unit 90 has received the operation signal 802 (step S100). Next, the projector 10 determines whether or not the receiving unit 90 has received a selection operation section operation signal (step S102). In the embodiment, whether or not a selection operation section operation signal has been received is determined by the picture processing unit 50.

If the receiving unit 90 has received a selection operation section operation signal, the projector 10 detects whether or not the receiving unit 90 has received the operation signal 802 within a predetermined time (step S112). Taking into consideration the user's realistic operating speed, it is acceptable to take the predetermined time to be, for example, one second. Next, the projector 10 determines whether or not a selection operation section operation signal corresponding to an operation of a selection operation section differing from that of the selection operation section operation signal detected in step S100 has been received (step S114). In the embodiment, whether or not a selection operation section operation signal corresponding to an operation of a selection operation section differing from that of the selection operation section operation signal detected in step S100 has been received is determined by the picture processing unit 50.

If the receiving unit 90, in step S112, has received a selection operation section operation signal corresponding to an operation of a selection operation section differing from that of the selection operation section operation signal detected in step S100, the projector 10 judges that the operation of the selection operation section corresponding to the selection operation section operation signal detected in step S100, and the operation of the selection operation section corresponding to the selection operation section operation signal detected in step S112, are operations carried out by the user simultaneously (step S114).

In this case, the picture processing unit 50 carries out the combined picture display process, generating the display picture signal 502 which represents a combined picture based on an image input signal corresponding to the selection operation section operation signal detected in step S100, and on an image input signal corresponding to the selection operation section operation signal detected in step S112 (step S118).

For example, in the event of detecting a selection operation section operation signal corresponding to an operation of the selection operation section 71 in step S100, and detecting a selection operation section operation signal corresponding to an operation of the selection operation section 72 in step S112, the projector 10 generates and displays a combined picture based on the image input signals 411 and 421 input into the image input sections 41 and 42, which correspond to the respective selection operation section operation signals.

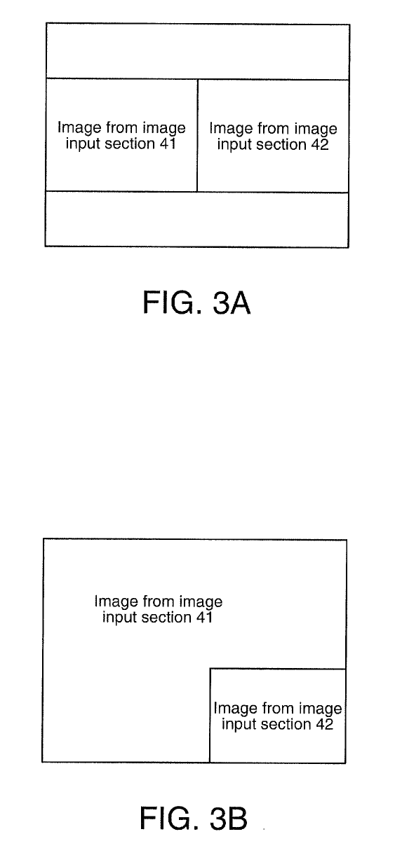

The size and disposition of the combined picture being optional, it is acceptable, for example, to display an image based on the image input signal 411 input into the image input section 41, and an image based on the image input signal 421 input into the image input section 42, in juxtaposition, as in the projection picture shown in FIG. 3A, or to display them superimposed (display them as a so-called picture-in-picture), with the image based on the image input signal 411 input into the image input section 41 as a main screen and, inside that, the image based on the image input signal 421 input into the image input section 42 as a sub-screen, as in the projection picture shown in FIG. 3B.

It is also acceptable that the picture processing unit 50 carries out the combined picture display process, generating the display picture signal 502 which represents a combined picture based on the image input signal corresponding to the selection operation section operation signal detected in step S100, and on the image input signal corresponding to the selection operation section operation signal detected in step S112, with a disposition correlated in advance to an operational order of the selection operation section operations. For example, a description will be given of a case in which the selection operation section operation signal corresponding to the operation of the selection operation section 71 is detected first, and the selection operation section operation signal corresponding to the operation of the selection operation section 72 is detected next

For example, in the case of displaying the image based on the image input signal 411 input into the image input section 41, and the image based on the image input signal 421 input into the image input section 42, in juxtaposition, as in the projection picture shown in FIG. 3A, it is acceptable that the picture processing unit 50 processes in such a way as to display the image based on the image input signal 411 input into the image input section 41, which corresponds to the first detected selection operation section operation signal corresponding to the operation of the selection operation section 71, on the left, and the image based on the image input signal 421 input into the image input section 42, which corresponds to the next detected selection operation section operation signal corresponding to the operation of the selection operation section 72, on the right.

Also, for example, in the case of displaying the image based on the image input signal 421 input into the image input section 42 superimposed inside the image based on the image input signal 411 input into the image input section 41, as in the projection picture shown in FIG. 3B, it is acceptable that the picture processing unit 50 processes in such a way as to display the image based on the image input signal 411 input into the image input section 41, which corresponds to the first detected selection operation section operation signal corresponding to the operation of the selection operation section 71, as the main screen, and the image based on the image input signal 421 input into the image input section 42, which corresponds to the next detected selection operation section operation signal corresponding to the operation of the selection operation section 72, as the sub-screen.

Also, in the event that, during the combined picture display process, the receiving unit 90 receives another combination of selection operation section operation signals in steps S100 and S112, it is acceptable that the picture processing unit 50 newly carries out the combined picture display process, generating the display picture signal 502 which represents a combined picture based on the image input signal corresponding to the selection operation section operation signal detected in step S100, and on the image input signal corresponding to the selection operation section operation signal detected in step S112.

For example, in the event that, when the picture processing unit 50 is partway through the combined picture display process, generating the display picture signal 502 which represents a combined picture based on the image input signals 411 and 421 input into the image input sections 41 and 42, the receiving unit 90 detects a selection operation section operation signal corresponding to an operation of the selection operation section 73 in step S100, and detects a selection operation section operation signal corresponding to an operation of the selection operation section 74 in step S112, it is acceptable that the picture processing unit 50 switches and carries out the combined picture display process in such a way that the projector 10 generates the display picture signal 502, which represents a combined picture based on the image input signals 431 and 441 input into the image input sections 43 and 44.

In the flowchart of FIG. 2, if the receiving unit 90, in step S112, has not received a selection operation section operation signal corresponding to an operation of a selection operation section differing from that of the selection operation section operation signal detected in step S100, the projector 10 judges that the user has carried out only the operation corresponding to the selection operation section operation signal detected in step S100 (step S114).

In this case, the picture processing unit 50 carries out the single picture display process, generating the display picture signal 502 which represents a single picture based on the image input signal corresponding to the selection operation section operation signal detected in step S100 (step S116).

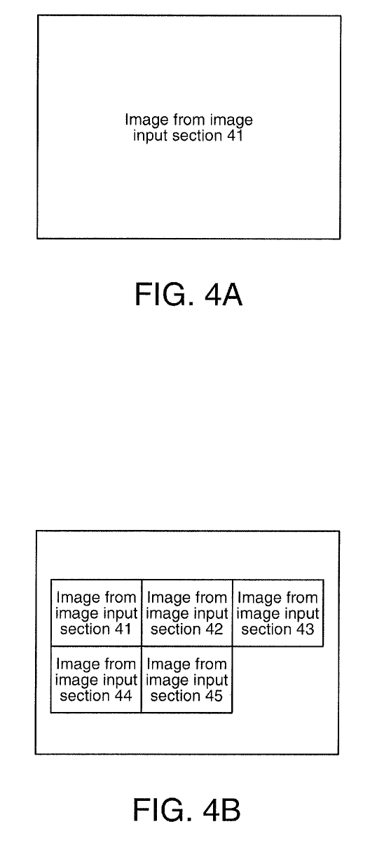

For example, in the event that a selection operation section operation signal corresponding to an operation of the selection operation section 71 is detected in step S100, but no selection operation section operation signal corresponding to an operation of the selection operation section 71 is detected in step S112, the projector 10 displays a single picture of an image based on the image input signal 411 input into the image input section 41, which corresponds to the selection operation section operation signal corresponding to the operation of the selection operation section 71. It is acceptable to make the disposition of the single picture, for example, a full-screen display of the image based on the image input signal 411 input into the image input section 41, as in the projection picture shown in FIG. 4A.

Also, in the event that, during the combined picture display process, the receiving unit 90 receives, in step S100, any one of the operation signals corresponding to the combined picture being projected, but the receiving unit 90 does not, in step S112, receive a selection operation section operation signal corresponding to an operation of a selection operation section differing from that of the selection operation section operation signal detected in step S100, it is acceptable that the picture processing unit 50 newly carries out the single picture display process, generating the display picture signal 502 which represents a single picture based on the image input signal corresponding to the selection operation section operation signal detected in step S100.

For example, in the event that, when the picture processing unit 50 is partway through the combined picture display process, generating and displaying a combined picture based on the image input signals 411 and 421 input into the image input sections 41 and 42, the receiving unit 90 detects a selection operation section operation signal corresponding to an operation of the selection operation section 71 in step S100, but does not detect a selection operation section operation signal corresponding to an operation of the selection operation section 71 in step S112, it is acceptable that the picture processing unit 50 switches from the combined picture display process to the single picture display process, and carries it out in such a way that the projector 10 generates the display picture signal 502, which represents a single picture of the image based on the image input signal input into the image input section 41.

In the flowchart of FIG. 2, if it is determined that the receiving unit 90 has not received a selection operation section operation signal in step S100 (step S102), the projector 10 determines whether or not a thumbnail operation section operation signal has been received (step S104). In the embodiment, whether or not a thumbnail operation section operation signal has been received is determined by the picture processing unit 50.

If a thumbnail operation section operation signal has been received, it is judged that the user has carried out an operation of the thumbnail operation section (step S104).

In this case, the picture processing unit 50 carries out the thumbnail picture display process, generating the display picture signal 502 which represents a combined picture based on all the image input signals input into the plurality of image input sections 41 to 45 (step S110).

For example, in the event that the receiving unit 90 has received a thumbnail operation section operation signal, the picture processing unit 50 carries out the thumbnail picture display process in such a way that the projector 10 generates and displays a combined picture of images based on all the image input signals input into the image input sections 41 to 45. The size and disposition of the thumbnail picture being optional, it is acceptable, for example, to display the images based on all the image input signals input into the image input sections 41 to 45 in juxtaposition, as in the projection picture shown in FIG. 4B.

In the flowchart of FIG. 2, if it is determined that the receiving unit 90 has not received a thumbnail operation section operation signal in step S100 (step S104), the projector 10 determines whether or not an other operation section operation signal has been received (step S106). In the embodiment, whether or not an other operation section operation signal has been received is determined by the picture processing unit 50.

If the receiving unit 90 has received an other operation section operation signal, the projector 10 carries out a corresponding other process (step S108). If the receiving unit 90 has not received an other operation section operation signal, the projector 10 repeats steps S100 to S106 until it detects an operation signal.

The order of determination of steps S102 to S106 is not particularly restricted.

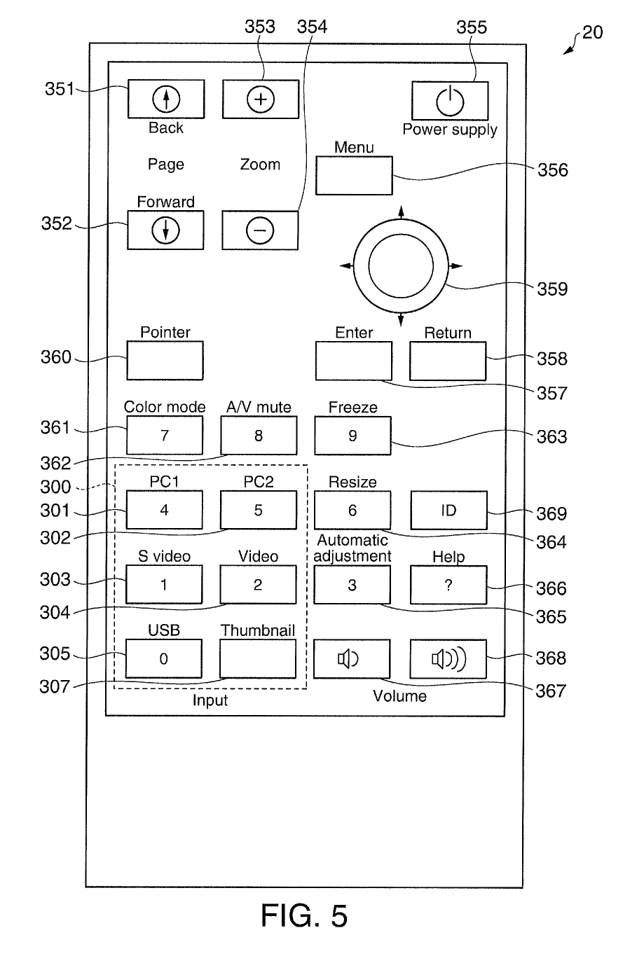

FIG. 5 is a diagram schematically showing one example of a specific configuration of the remote controller 20. A description will be given of an example of the remote controller used in the projector 10, allotting an RS-232C terminal (hereafter referred to as the “PC1”) as the image input section 41, a DVI terminal (hereafter referred to as the “PC2”) as the image input section 42, an S video terminal (hereafter referred to as the “S video”) as the image input section 43, a component video terminal (hereafter referred to as the “video”) as the image input section 44, and a USB terminal (hereafter referred to as the “USB”) as the image input section 45.

The remote controller 20 includes a button group 300 corresponding to the heretofore described operation unit 70. Buttons 301 to 305, corresponding to the heretofore described selection operation sections 71 to 75, and a button 307, corresponding to the heretofore described thumbnail operation section 77, are included in the button group 300.

In the embodiment, the button 301 corresponds to an input from the PC1, the button 302 to an input from the PC2, the button 303 to an input from the S video, the button 304 to an input from the video, and the button 305 to an input from the USB.

It is acceptable that the remote controller 20 includes, apart from the above, page operation buttons 351 and 352, zoom operation buttons 353 and 354, a power supply button 355, menu operation buttons 356 to 358, a menu operation key 359, a pointer display button 360, a color mode setting button 361, an A/V mute button 362, a freeze button 363, a resize button 364, an automatic adjustment button 365, a help button 366, volume setting buttons 367 and 368, and the like. The user operates the remote controller 20 by pressing, or the like, these buttons.

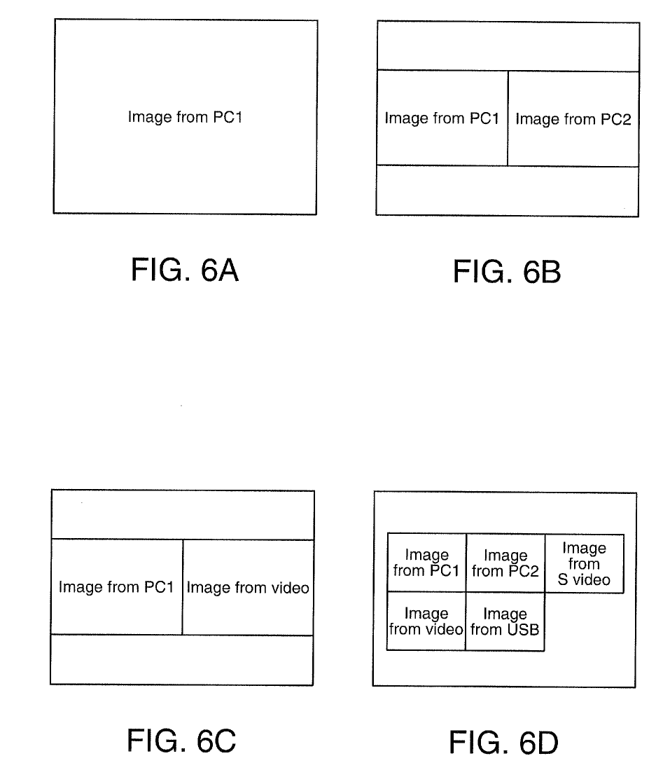

FIGS. 6A to 6D are diagrams for illustrating a relationship in the embodiment between an operation of the remote controller 20 and an image projected by the projector 10.

Firstly, it is taken that the projector 10 is displaying a single picture of an image based on an image input signal from the PC1 (FIG. 6A).

In the event that the user operates the buttons 301 and 302 within the predetermined time during the single picture display, the projector 10 displays a combined picture of images based on image input signals from the PC1 and PC2, corresponding to the buttons 301 and 302 (FIG. 6B).

In the event that the user operates the buttons 301 and 304, which are another combination, within the predetermined time during this combined picture display, the projector 10 displays a combined picture of images based on image input signals from the PC1 and video, corresponding to the buttons 301 and 304 (FIG. 6C).

In the event that the user, within the predetermined time during this combined picture display, operates only the button 301 corresponding to the image based on the image input signal from the PC1, which is being projected, the projector 10 displays a single picture of the image based on the image input signal from the PC1, corresponding to the button 301 (FIG. 6A).

Regardless of whether there is a single picture display in progress or a combined picture display in progress, in the event that the user operates the button 307, the projector 10 combines images based on all the image input signals from the PC1, PC2, S video, video, and USB, and displays a thumbnail picture (FIG. 6D).

In the event that the user, within the predetermined time during the thumbnail picture display, operates only the button 301, the projector 10 displays a single picture of the image based on the image input signal from the PC1, corresponding to the button 301 (FIG. 6A).

Also, in the event that the user operates the buttons 301 and 302 within the predetermined time during the thumbnail picture display, the projector 10 displays a combined picture of images based on the image input signals from the PC1 and PC2, corresponding to the buttons 301 and 302 (FIG. 6B). By making an image the user wishes to display selectable during the thumbnail picture display, the user can select it easily and quickly.

It is acceptable to configure the remote controller 20 in such a way that it is possible to specify an identification number (ID number) given to the projector main body, in order that it is possible to operate a plurality of projector main bodies with one remote controller. For example, the user, by operating the button 305, 303, 304, 365, 301, 302, 364, 361, 362, or 363, corresponding to each identification number, after operating a switching button 369, can specify the identification number given to the projector main body. In this case, the buttons 301 to 305 have both the role as the selection operation sections and the role of specifying the identification number.

In the embodiment, a description has been given of an example wherein the operation unit 70 is configured as the remote controller 20, but it is also possible to configure the operation unit 70 integrated with the projector 10. In this case, it is acceptable that the signal generation and transmission unit 80 functions as a signal generation unit, and the picture processing unit 50 directly accepts the operation signal 802 output by the signal generation unit.

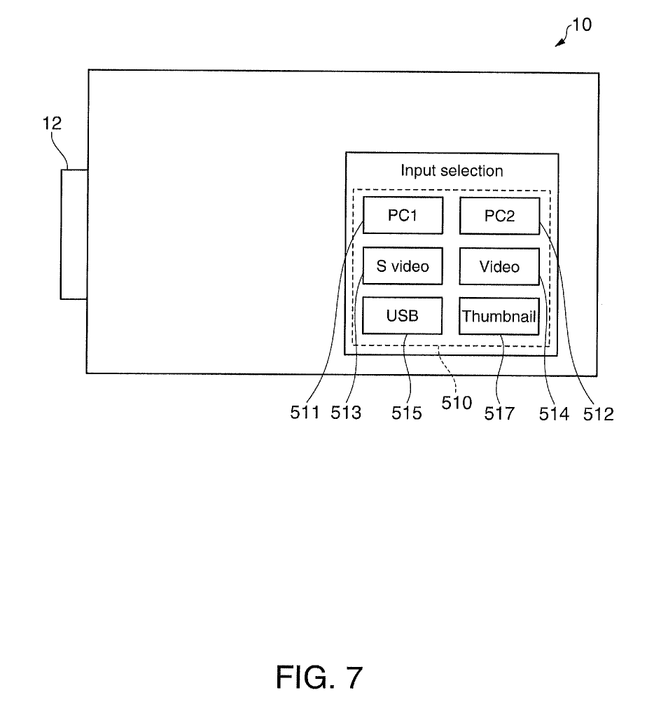

FIG. 7 is a diagram schematically showing one example of an operation screen in the case of providing the projector 10 with the operation unit 70. The projector 10 includes a button group 510 which corresponds to the heretofore described operation section group 700. Buttons 511 to 515, corresponding to the heretofore described selection operation sections 71 to 75, and a button 517, corresponding to the heretofore described thumbnail operation section 77, are included in the button group 510. It is acceptable that the projector 10 includes other operation sections.

In the embodiment, the button 511 corresponds to an input from the PC1, the button 512 to an input from the PC2, the button 513 to an input from the S video, the button 514 to an input from the video, and the button 515 to an input from the USB. The user operates the operation unit 70 by pressing, or the like, the buttons. It is also acceptable to display as, for example, button areas 511 to 515, corresponding to the selection operation sections 71 to 75, and a button area 517, corresponding to the thumbnail operation section 77, on a touch panel, rather than as buttons.

A correspondence relationship between the operation of the button group 510 and an image projected by the projector 10 is the same as the correspondence relationship between the operation of the remote controller 20 and an image projected by the projector 10, illustrated with reference to FIGS. 6A to 6D.

According to the projector of the embodiment, as there is no need to provide a special operation unit for switching from a single picture display to a combined picture display, it is possible to provide a projector wherein, without increasing a number of parts in an operation portion, it is possible to intuitively select a combination of images from a plurality of image input sections.

Also, according to the remote controller of the embodiment, as there is no need to provide a special operation unit for switching from a single picture display to a combined picture display, it is possible to provide a remote controller wherein, without increasing a number of parts in an operation portion, it is possible to intuitively select a combination of images from a plurality of image input sections.

The invention includes configurations which are essentially the same as the configurations described in the embodiment (for example, configurations having the same function, method and result, or configurations having the same object and advantage). Also, the invention includes configurations which substitute a non-essential portion of the configurations described in the embodiment. Also, the invention includes configurations which produce the same effect, or configurations which can achieve the same object, as the configurations described in the embodiment. Also, the invention includes configurations which add heretofore known technology to the configurations described in the embodiment.

For example, in the heretofore described embodiment, a description has been given of an example wherein a combined picture of two images is displayed, but it is also acceptable to display a combined picture of three or more images.

Also, although a projector system has been illustrated in the heretofore described embodiment, it is possible to employ, in place of the projector, a picture display apparatus using various kinds of flat panel display or cathode ray tube (CRT).

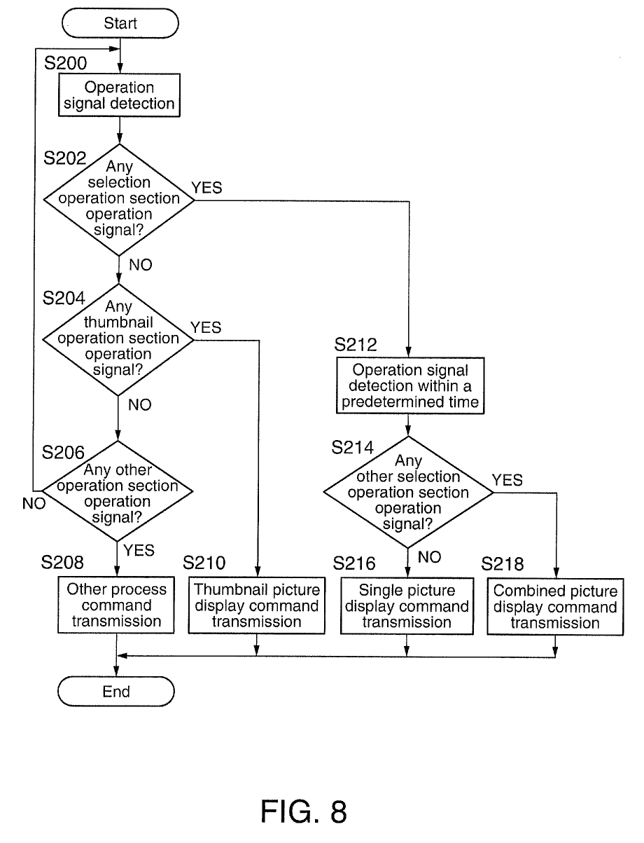

Also, in the heretofore described embodiment, a description has been given of an example wherein a combination of operation signals transmitted from the remote controller 20 are judged by the projector 10, and processing details decided on, but it is also acceptable that the remote controller 20 generates an operation signal corresponding to a combination of operations carried out by the user, and transmits it to the projector 10. FIG. 8 is a flowchart applied to this modification example. A detection of the operation signal corresponding to the operations carried out by the user, and a determination of an operation category, can be carried out by the signal generation and transmission unit 80. It is also acceptable to provide a detection unit for detecting an existence or non-existence, and the category, of the operation signal, separately from the signal generation and transmission unit 80. The remote controller 20 carries out various determinations (steps S202, S204, S206, and S214), and transmits appropriate commands to the projector 10 (steps S208, S210, S216, and S218). According to this kind of configuration, as the remote controller 20 transmits the operation signal 802 corresponding to the combination of operations carried out by the user within the predetermined time, the projector 10 can carry out a process in response to the received operation signal.

The entire disclosure of Japanese Patent Application Nos. 2008-042784, filed Feb. 25, 2008 is expressly incorporated by reference herein.

What is claimed is:

1. A projector system comprising:
a projector which has a plurality of image input sections receiving image input signals, and a remote controller which remotely operates the projector,
the remote controller including:
an operation unit which has a plurality of selection operation sections correlated to the plurality of image input sections; and
a signal generation and transmission unit which generates an operation signal corresponding to an operation of each of the selection operation sections, and transmits it to the projector, and
the projector including:
a receiving unit which receives the operation signal transmitted by the signal generation and transmission unit;
a picture processing unit which generates a display picture signal from the image input signals, based on the operation signal received by the receiving unit; and
a projection section which projects a picture based on the display picture signal, wherein
in the event that the receiving unit receives at least two of the operation signals within a predetermined time, the picture processing unit generates a display picture signal which represents a combined picture based on the image input signals corresponding to the operation signals received within the predetermined time.

2. The projector system according to claim 1, wherein
in the event that the receiving unit receives at least two of the operation signals in operational order within the predetermined time, the picture processing unit generates a display picture signal which represents a combined picture, with a disposition correlated in advance to the operational order, based on the image input signals corresponding to the operation signals received within the predetermined time.

3. The projector system according to claim 1, wherein
in the event that the receiving unit receives any one of the operation signals corresponding to the combined picture being projected, the picture processing unit generates a display picture signal which represents a single picture based on the image input signal corresponding to the operation signal received.

4. The projector system according to claim 1, wherein
the operation unit includes a thumbnail operation section,
the signal generation and transmission unit generates a thumbnail operation signal corresponding to an operation of the thumbnail operation section, and transmits it to the projector, and
in the event that the receiving unit receives the thumbnail operation signal, the picture processing unit generates a display picture signal which represents a combined picture based on all the image input signals input into the plurality of image input sections.

5. A projector which has a plurality of image input sections receiving image input signals, comprising:
an operation unit which has a plurality of selection operation sections correlated to the plurality of image input sections;
a signal generation unit which generates an operation signal correlated to an operation of each of the selection operation sections;
a picture processing unit which generates a display picture signal from the image input signals, based on the operation signal; and
a projection section which projects a picture based on the display picture signal, wherein
in the event that the picture processing unit accepts at least two of the operation signals within a predetermined time, the picture processing unit generates a display picture signal which represents a combined picture based on the image input signals corresponding to the operation signals accepted within the predetermined time.

6. The projector according to claim 5, wherein
in the event that the picture processing unit accepts at least two of the operation signals in operational order within the predetermined time, the picture processing unit generates a display picture signal which represents a combined picture, with a disposition correlated in advance to the operational order, based on the image input signals corresponding to the operation signals accepted within the predetermined time.

7. The projector according to claim 5, wherein
in the event that the picture processing unit accepts any one of the operation signals corresponding to the combined picture being projected, the picture processing unit generates a display picture signal which represents a single picture based on the image input signal corresponding to the operation signal accepted.

8. The projector according to claim 5 further comprising a thumbnail operation section for sending a thumbnail operation signal, wherein
in the event that the picture processing unit accepts the thumbnail operation signal corresponding to an operation of the thumbnail operation section, the picture processing unit generates a display picture signal which represents a combined picture based on all the image input signals input into the plurality of image input sections.

9. A picture display system comprising:
a picture display apparatus which has a plurality of image input sections receiving image input signals, and a remote controller which remotely operates the picture display apparatus,
the remote controller including:
an operation unit which has a plurality of selection operation sections correlated to the plurality of image input sections; and
a signal generation and transmission unit which generates an operation signal corresponding to an operation of each of the selection operation sections, and transmits it to the projector, and
the picture display apparatus including:
a receiving unit which receives the operation signal transmitted by the signal generation and transmission unit;
a picture processing unit which generates a display picture signal from the image input signals, based on the operation signal received by the receiving unit; and
a display section which displays a picture based on the display picture signal, wherein
in the event that the receiving unit receives at least two of the operation signals within a predetermined time, the picture processing unit generates a display picture signal which represents a combined picture based on the image input signals corresponding to the operation signals received within the predetermined time.

10. A picture display apparatus which has a plurality of image input sections receiving image input signals, comprising:
an operation unit which has a plurality of selection operation sections correlated to the plurality of image input sections;
a signal generation unit which generates an operation signal corresponding to an operation of each of the selection operation sections;
a picture processing unit which generates a display picture signal from the image input signals, based on the operation signal; and
a display section which displays a picture based on the display picture signal, wherein
in the event that the picture processing unit accepts at least two of the operation signals within a predetermined time, the picture processing unit generates a display picture signal which represents a combined picture based on the image input signals corresponding to the operation signals accepted within the predetermined time.

11. A remote controller which remotely operates a picture display apparatus which has a plurality of image input sections receiving image input signals, comprising:
an operation unit which has a plurality of selection operation sections correlated to the plurality of image input sections; and
a signal generation and transmission unit which generates an operation signal corresponding to an operation of each of the selection operation sections, and transmits it to the picture display apparatus, wherein
the operation unit includes a thumbnail operation section, and
the signal generation and transmission unit generates a thumbnail operation signal, corresponding to an operation of the thumbnail operation section, instructing a display of a combined picture based on all the image input signals input into the plurality of image input sections, and transmits it to the projector.
